(19) United States
(12) Patent Application Publication
(10) Pub. No.: US 2010/0005690 A1
(43) Pub. Date: Jan. 14, 2010

(54) Advertising sign

(76) Inventor: Mark R. Mavis, Eden Prairie, MN (US)

Correspondence Address: Mark A. Litman & Associates;York Business Center, Suite 205, 3209 West 76th St., Edina, MN, 55435, US

(21) Appl. No.: 12/217,847

(22) Filed: Jul. 10, 2008

(51) Int. Cl. G09F 11/02; F16M 11/38

(52) U.S. Cl. 40/1; 248/168

(57) ABSTRACT

A system displays information. The system has at least two panels. There may be three or four panels, but two panels are the most space efficient and easily constructed. The at least two panels each have a top edge and a bottom edge. The bottom edge of each panel forms at least two contact points for supporting the system. A support element is supported by at least one of the at least two panels. It is preferred that the support element is secured to both panels. The support element supports an elongate element, with a first portion of the elongate element extending above the top edge of the at least two panels and a second portion of the elongate element extending below the top edge of the at least two panels. A frequency stabilizing element is attached to the second portion of the elongate element. A display device is attached to the first portion of the elongate element. The support element supports the elongate element so as to allow the elongate element with the display device thereon to swing freely.

### BACKGROUND OF THE INVENTION

1. Field of the Invention

The present invention relates to signs and public displays of information on simple moveable and adjustable carriers.

2. Background of the Art

Signs are convenient and effective ways of communicating information. Signs may be as simple as pages adhered to walls or windows, or much more complex methods such as billboards. Electronic signs, and even sky-writing. Warnings and public notices, and local advertising are often on moveable and collapsible signs such as traffic signs, post signs and sandwich signs.

Sandwich signs are similar to one-half of a saw horse, two H-shaped structural elements secured along a common, hinged line. Legs on the sandwich sign are spread as the hinges pivot and a stable support for signs on opposed faces (the H's) are displayed in opposite directions. This is a simple and inexpensive method of providing public information, but it is very staid and is not particularly attractive.

Some attempts to provide more active and attention-attracting signage includes U.S. Pat. Nos. 6,749,394; 4,019,271; and 3,899,843.

### SUMMARY OF THE INVENTION

A moveable sign has a vertical support associated with it. The vertical support carries signage that can move in at least two dimensions and possibly rotate. The signage may have 2, 3, 4 or more display surfaces. The vertical support may be a straight or curves or sinusoidal pole or bar that can swing in at least one and possibly two axes and/or rotationally.

### BRIEF DESCRIPTION OF THE INVENTION

Two panels are provided in a hinged or other adjustable relationship to be able to sit on the ground when opened to form four-point contact on the ground (two line, either intersecting, askew or parallel contact with the ground will effect this also). An opening through the top of the two panels is structured to support an elongate (preferably vertically oriented) element (such as a pole). The vertical element can swing in at least one arcuate direction, preferably at least two arcuate directions, and preferably along all angles in a 360 degree arc.

A lower portion of the elongate element (below the top of the panels) is weighted or spring supported or stabilized. An upper portion of the elongate element supports signage, writing, decorations and the like. The elongate element is moved by the wind or manual contact and can then swing, pivot and/or rotate about a support point on or supported by the panels.

### BRIEF DESCRIPTION OF THE FIGURES

FIG. 1 shows a perspective view of a signage system according to the present technology.

FIG. 2 shows a combination perspective and exploded view of a signage system according to the present technology.

### DETAILED DESCRIPTION OF THE INVENTION

Two panels are provided in a hinged or other adjustable relationship to be able to sit on the ground when opened to form four-point contact on the ground (two line, either intersecting, askew or parallel contact with the ground will effect this also). The panels can be flat and solid, flat and open (e.g., in shape of an A or H with a top bar parallel to the ground) or perforated, faces of the panels may be curved or the like. The panels may be made of any structural material, such as wood, polymer, plastics, composites, metals or combinations thereof.

An opening through the top of the two panels is structured to support an elongate (preferably vertically oriented) element (such as a pole). The opening may be a natural separation between upper portions of the panels or an opening designed and built into upper area(s) of the panels. A support component or support point may be a structural piece connected to one or both panels. An opening in the support is shaped to support the elongate element in a relatively vertical position when stable. The opening may be round, oval, square, or another geometric (regular or irregular) shape. The selection of shape can be used to influence motion of the elongate element as it swings. The vertical element can swing in at least one arcuate direction, preferably at least two arcuate directions, and preferably along all angles in a 360 degree arc.

A lower portion of the elongate element (below the top of the panels) is weighted or spring supported or stabilized. The height and mass of the weight can influence the frequency of the swinging motion. By having the weight moveable along the lower portion of the elongate element or having the elongate element moveable with respect to the support point, the frequency and stability in different wind conditions can be adjusted.

An upper portion of the elongate element supports imagery such as signage, writing, decorations and the like. The imagery may be on a geometric surface (spherical, ovoid, cubic, etc.), flat surface(s) or irregular surfaces. A simple panel (with front and rear faces) may be used, or more complex and decorative and functional faces and surfaces may be used. A triangular, cubic, vertical, angles or multi-leaf panel may be used.

The elongate element is moved by the wind or manual contact and can then swing, pivot and/or rotate about a support point on or supported by the panels.

Reference to the Figures will assist in a better appreciation of the present technology.

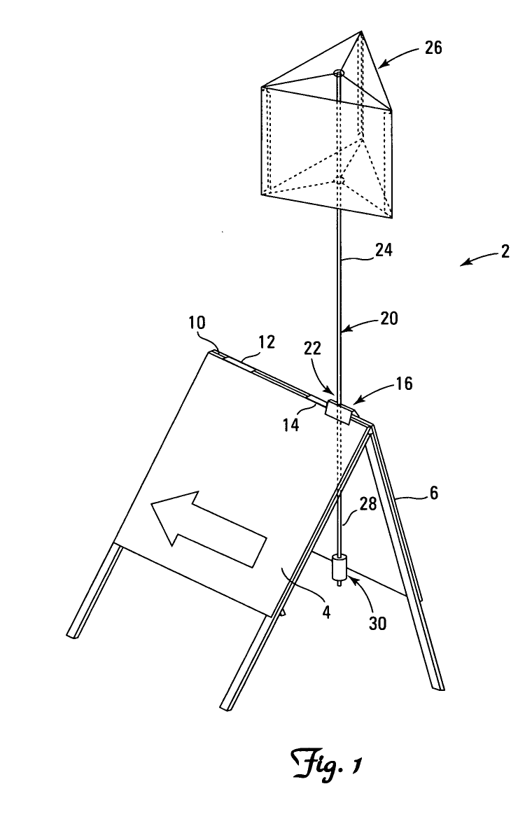

FIG. 1 shows one example of a signage system 2 according to the present technology. The system 2 is shown with a front panel 4 and a rear panel 6. The two panels 4 and 6 share a common line 10 where they are connected by hinges 12 and 14. A support element 16 is shown along the common line 10. The support element 16 is a solid bracket or ring secured to both panels 4 and 6. An elongate element 20 is supported in the support element 16 by an adjustable barrier 22. The adjustable barrier 22 may be a clamp or elastic secured grip, or a slide joint so that an upper portion 24 of the elongate element 20 can telescope upwardly to adjust view of the sign 26 and the frequency of the motion, or the lower portion 28 of the elongate element 20 for similar effects. An adjustable weight 30 (adjustable in position and mass) is present on the lower portion 28 of the elongate element 20.

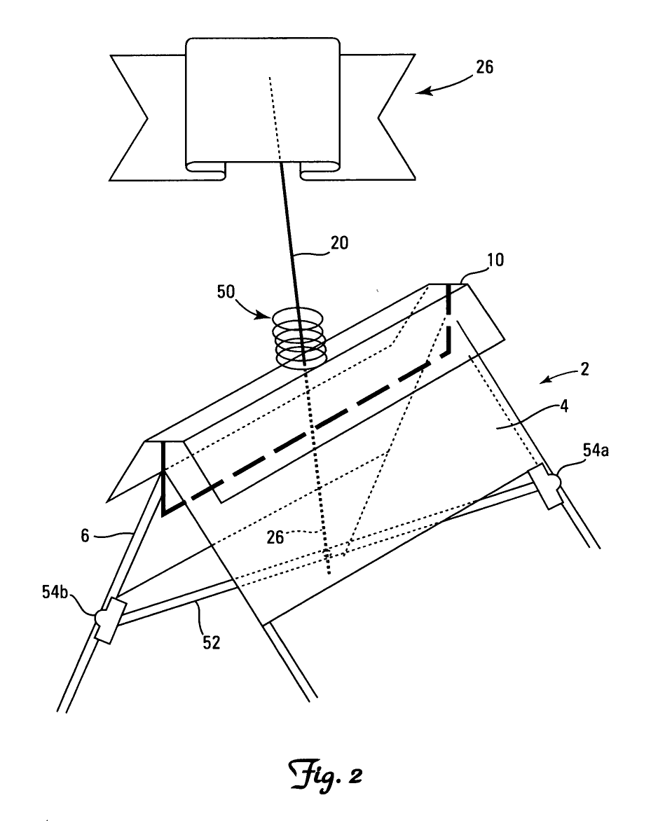

FIG. 2 shows an alternative embodiment of a signage system 2 according to the present invention, where like numbers describe like elements. The stabilizing element 50 in this Figure is a spring, here shown above the common line 10, although it may also be present below the common line 10, between the front panel 4 and the rear panel 6. An elastic strap 52 is shown stabilizing the two panels 4 and 6. Elements 54a and 54b can be tightening elements (e.g., thumb screws or wing nuts, or reels) that can be used to adjust tension on the elastic strap. By securing the lower portion 28 of the elongate element 20 to the elastic strap 52, additional stability or independent stability can be provided to the elongate element and the frequency of the sign 26.

The technology described herein may be summarized as a system for displaying information. The system has at least two panels. There may be three or four panels, but two panels are the most space efficient and easily constructed. The at least two panels each have a top edge and a bottom edge. The bottom edge of each panel forms at least two contact points for supporting the system. A support element is supported by at least one of the at least two panels. It is preferred that the support element is secured to both panels. The support element supports an elongate element, with a first portion of the elongate element extending above the top edge of the at least two panels and a second portion of the elongate element extending below the top edge of the at least two panels. A frequency stabilizing element is attached to the second portion of the elongate element. A display device is attached to the first portion of the elongate element. The support element supports the elongate element so as to allow the elongate element with the display device thereon to swing freely.

There may be two panels and their upper edges may define a common line, and hinges (e.g., living hinge or attached metal or plastic hinges) may secure the two panels along the common edge. This enables the system to be collapsed and readily installed. The frequency stabilizing device may comprise a weight attached to the second portion of the elongate element or a spring attached to the second portion of the elongate element. The elongate element may be able to telescope to adjust a length of the elongate element. The display device may comprise signs with at least one of images and alphanumerics on one or more visible surfaces. The display device may comprise signs with at least one of images and alphanumerics on at least two visible surfaces and the elongate element can swing at at least four different angles. To effect this, there may be at least four specific angles across which the elongate element may swing (e.g., the support element may have four grooves therein into which the elongate element may swing) or be able to swing through at least 180 degrees or the elongate element can swing through about 360 degrees. The display device may comprise signs with at least one of images and alphanumerics on at least two visible surfaces, with a continuous or discontinuous face or panel. A discontinuous face may comprise two legs and two connecting bars.

Many variations using the underlying technology described herein may be practiced. Specific numbers, sizes, shapes and materials may be varied to meet specific needs. The weights, for example, may be a battery pack and power lights on the signage.

Also mentioned above was the use of springs to stabilize and control the frequency of the sign movement. This would be done by securing a spring at one or more points along the lower length of the elongated element and one or more of the panels or attachments on the panels.

What is claimed:

1. A system for displaying information comprising:
at least two panels;
the at least two panels each having a top edge and a bottom edge;
the bottom edge of each panel forming at least two contact points for supporting the system;
a support element supported by at least one of the at least two panels;
the support element supporting an elongate element, with a first portion of the elongate element extending above the top edge of the at least two panels and a second portion of the elongate element extending below the top edge of the at least two panels;
a frequency stabilizing element attached to the second portion of the elongate element; and
a display device attached to the first portion of the elongate element;
wherein the support element supports the elongate element so as to allow the elongate element with the display device thereon to swing freely.

2. The system of claim 1 wherein there are two panels and their upper edges define a common line.

3. The system of claim 2 wherein the common line is hinged to enable the system to be collapsed.

4. The system of claim 3 wherein the frequency stabilizing device comprises a weight attached to the second portion of the elongate element.

5. The system of claim 3 wherein the frequency stabilizing device comprises a spring attached to the second portion of the elongate element.

6. The system of claim 3 wherein the elongate element can telescope to adjust a length of the elongate element.

7. The system of claim 2 wherein the display device comprises signs with at least one of images and alphanumerics on a visible surface.

8. The system of claim 4 wherein the display device comprises signs with at least one of images and alphanumerics on at least two visible surfaces.

9. The system of claim 3 wherein the display device comprises signs with at least one of images and alphanumerics on at least two visible surfaces.

10. The system of claim 4 wherein the display device comprises signs with at least one of images and alphanumerics on at least two visible surfaces and the elongate element can swing at at least four different angles.

11. The system of claim 4 wherein the elongate element can swing through at least 180 degrees.

12. The system of claim 4 wherein the elongate element can swing through about 360 degrees.

13. The system of claim 12 wherein the display device comprises signs with at least one of images and alphanumerics on at least two visible surfaces.

14. The system of claim 10 wherein each panel has a continuous face.

15. The system of claim 10 wherein at least one panel has a discontinuous face.

16. The system of claim 10 wherein at least one panel has a discontinuous face comprising two legs and two connecting bars.
